(19) United States
(12) Patent Application Publication
(10) Pub. No.: US 2015/0033722 A1
(43) Pub. Date: Feb. 5, 2015

(54) TURBINE SYSTEM FOR GENERATING POWER FROM A FLOW OF LIQUID, AND RELATED SYSTEMS AND METHODS

(71) Applicant: HYDROVOLTS, INC., Seattle, WA (US)

(72) Inventors: Michael Layton, Seattle, WA (US); James Styner, Kirkland, WA (US); Brian Peithman, Seattle, WA (US); Jason Rota, Federal Way, WA (US); Dane Roth, Seattle, WA (US)

(21) Appl. No.: 14/379,490

(22) PCT Filed: Feb. 18, 2013
(86) PCT No.: PCT/US13/26600

§ 371 Date: Aug. 18, 2014

Related U.S. Application Data
(60) Provisional application No. 61/600,627, filed on Feb. 18, 2012.

(51) Int. Cl. F03B 13/08; E02B 9/02; F03B 15/14; E02B 9/00

(52) U.S. Cl. CPC F03B 13/08; E02B 9/00; E02B 9/027; F03B 15/14
USPC 60/327; 60/398; 60/706; 405/87; 405/107

(57) ABSTRACT

A turbine system that can be releasably anchored in a flow of liquid, like a waterfall, and generate power from the flow includes a runner operable to receive some or all of the flow of liquid and rotate to generate power, a penstock operable to direct some or all of the flow toward the runner, and an intake operable to direct some or all of the flow into the penstock. The runner may be coupled to a generator to generate electric power. The penstock has a length that is adjustable to accommodate changes in the height of the liquid drop or waterfall, which may be desirable if the distance between the top and bottom of the drop fluctuates like an ocean's tide. The turbine system also includes a valve operable to modify the flow of the liquid flowing into the runner, and a control circuit operable to determine an amount of liquid entering the penstock and, in response to the determined amount, move the valve to increase or decrease the flow of liquid into the runner. In addition, the turbine system includes an anchor to releasably hold the system in the flow of

### CROSS REFERENCE TO RELATED APPLICATIONS AND CLAIM OF PRIORITY

This application claims priority from commonly owned U.S. Provisional Patent Application 61/600,627 filed 18 Feb. 2012, titled “Banki Set”, which is presently pending and incorporated by reference.

### BACKGROUND

Extracting energy from a flowing liquid, such as water, is an effective way to generate power such as electricity. This is especially true when gravity causes the liquid to flow, such as a river that drains water from a mountain where the water fell as rain or snow. Because clouds, wind and gravity move the water, one doesn't spend effort or energy moving the water, and thus one only has to extract the energy from the flowing liquid.

Extracting energy from water flowing in a river is typically done by damming the river and directing much of the water flowing through the dam into a turbine system that converts water pressure in the flow into electricity by rotating a magnet surrounded by an electrical conductor. Such turbine systems include a runner that is designed to extract energy from the water pressure under a narrow set of specific flow conditions. By designing the turbine system for a narrow set of specific conditions, the turbine system can extract a maximum amount of energy from the flowing water. The two primary flow conditions are the water's rate of flow and the water's pressure at the runner. Because these flow conditions need to remain constant to allow the turbine system to extract a maximum amount of energy, many dams have a spillway to allow excess water entering the lake created by the dam to leave the lake without significantly changing the conditions of the water flowing through the turbine system. Many of these spillways simply direct the excess water downstream without extracting energy from the flow, and thus waste the energy in the flow generated by gravity.

Similar to a spillway of a darn, water freefalling as a waterfall is typically not directed to a turbine system to extract some of the energy generated by gravity. For example the energy in water tumbling over Niagra falls is not extracted. Instead, some of the water approaching the falls is directed to a turbine system that is designed to efficiently extract energy from a flow of water having a narrow set of specific characteristics. Many manufacturing plants and water treatment plants discharge water from the plant into a river, lake or ocean. To accommodate the river's flood stages and/or the ocean's high tide, many of the discharges are elevated and thus create a waterfall. Many of these waterfalls contain energy that could be used to generate power but isn't.

### SUMMARY

In an aspect of the invention, a turbine system that can be releasably anchored in a flow of liquid, like a waterfall, and generate power from the flow includes a runner operable to receive some or all of the flow of liquid and rotate to generate power, a penstock operable to direct some or all of the flow toward the runner, and an intake operable to direct some or all of the flow into the penstock. The runner may be coupled to a generator to generate electric power. The penstock has a length that is adjustable to accommodate changes in the height of the liquid drop or waterfall, which may be desirable if the distance between the top and bottom of the drop fluctuates like an ocean's tide. The turbine system also includes a valve operable to modify the flow of the liquid flowing into the runner, and a control circuit operable to determine an amount of liquid entering the penstock and, in response to the determined amount, move the valve to increase or decrease the flow of liquid into the runner. In addition, the turbine system includes an anchor to releasably hold the system in the flow of liquid.

With the anchor, the turbine system can be quickly and easily mounted to a structure that the liquid flows over to create the drop or that is near the drop. Thus, the turbine system can be quickly and easily moved to one or more different structures, as desired, to extract energy from a flow of liquid wherever the flow drops. With the penstock's adjustable length, the turbine system can be modified as the conditions of the flow change. Thus, the turbine system can be used to extract a substantial amount of energy from a flow of liquid that drops a distance even when the distance of the drop changes over time.

### BRIEF DESCRIPTION OF THE FIGURES

FIG. 1 is a perspective view of two turbine systems, each according to an embodiment of the invention.

FIG. 2A is a partial side view of the turbine systems in FIG. 1 showing a side view of an anchor, according to an embodiment of the invention.

FIG. 2B is a partial side view of a turbine system showing a side view of another anchor, according to another embodiment of the invention.

FIG. 3A is a perspective view of a penstock included in each of the turbine systems in FIG. 1, according to an embodiment of the invention.

FIG. 3B is a cross-sectional view of a penstock, according to another embodiment of the invention.

FIG. 3C is a perspective view of a penstock, according to yet another embodiment of the invention.

FIG. 4 is a perspective view of an intake included in each of the turbine systems in FIG. 1, according to an embodiment of the invention.

FIG. 5A is a cross-sectional view of a portion of each of the turbine systems in FIG. 1 that shows a valve included in each of the turbine systems, according to an embodiment of the invention.

FIG. 5B is a schematic view of liquid flowing through the valve shown in FIG. 5A, according to an embodiment of the invention.

FIG. 6 is a schematic view a control circuit included in each of the turbine systems in FIG. 1, according to an embodiment of the invention.

FIG. 7 is a perspective view of a runner included in each of the turbine systems in FIG. 1, according to an embodiment of the invention.

FIGS. 8A and 8B are views of a runner, according to another embodiment of the invention.

FIGS. 9A and 9B are views of a runner, according to yet another embodiment of the invention.

FIG. 10 is a perspective view of a levee included in the turbine systems in FIG. 1, according to an embodiment of the invention.

FIG. 11 is a schematic view of a turbine system in a drop inclined less than 90°, according to an embodiment of the invention.

### DETAILED DESCRIPTION

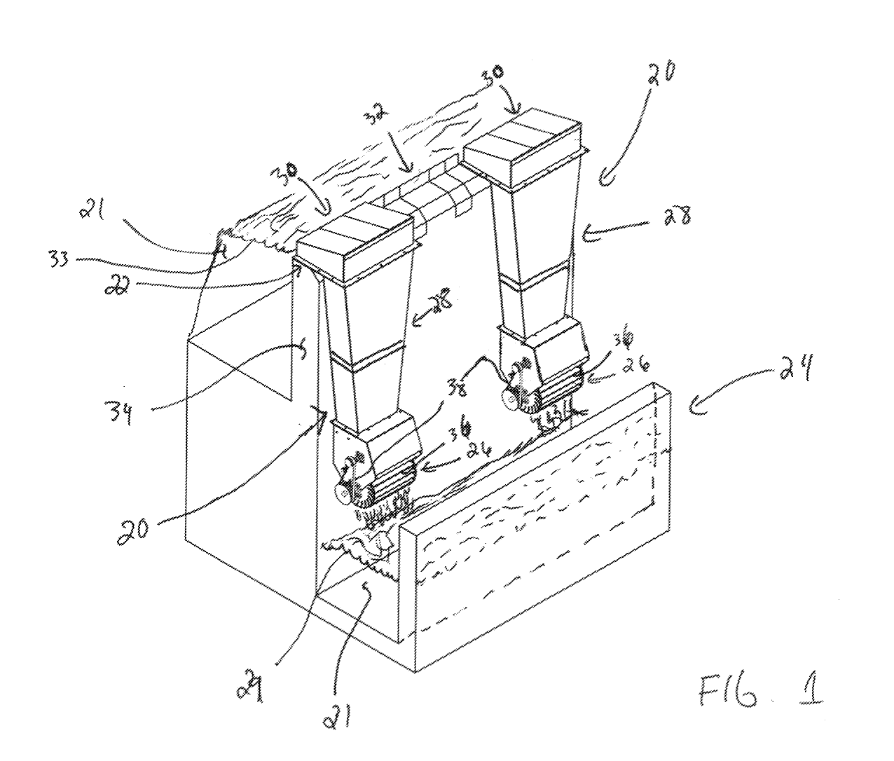

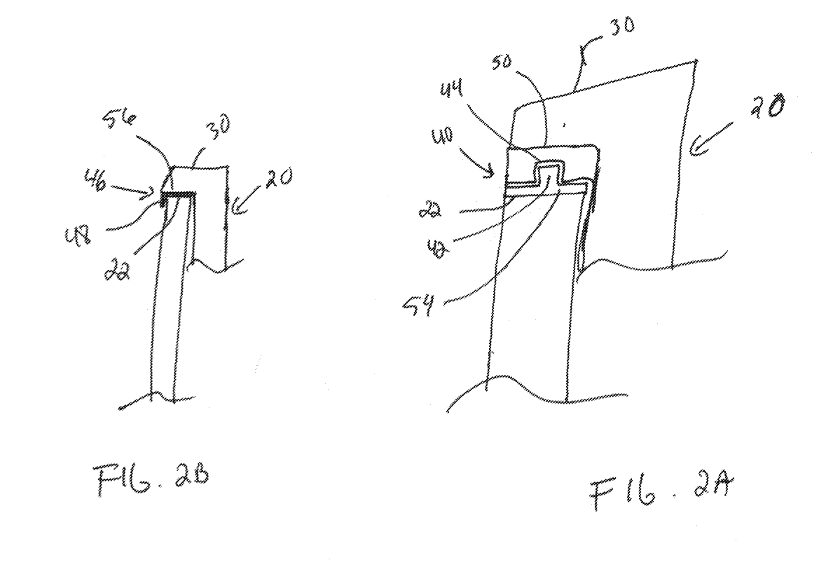

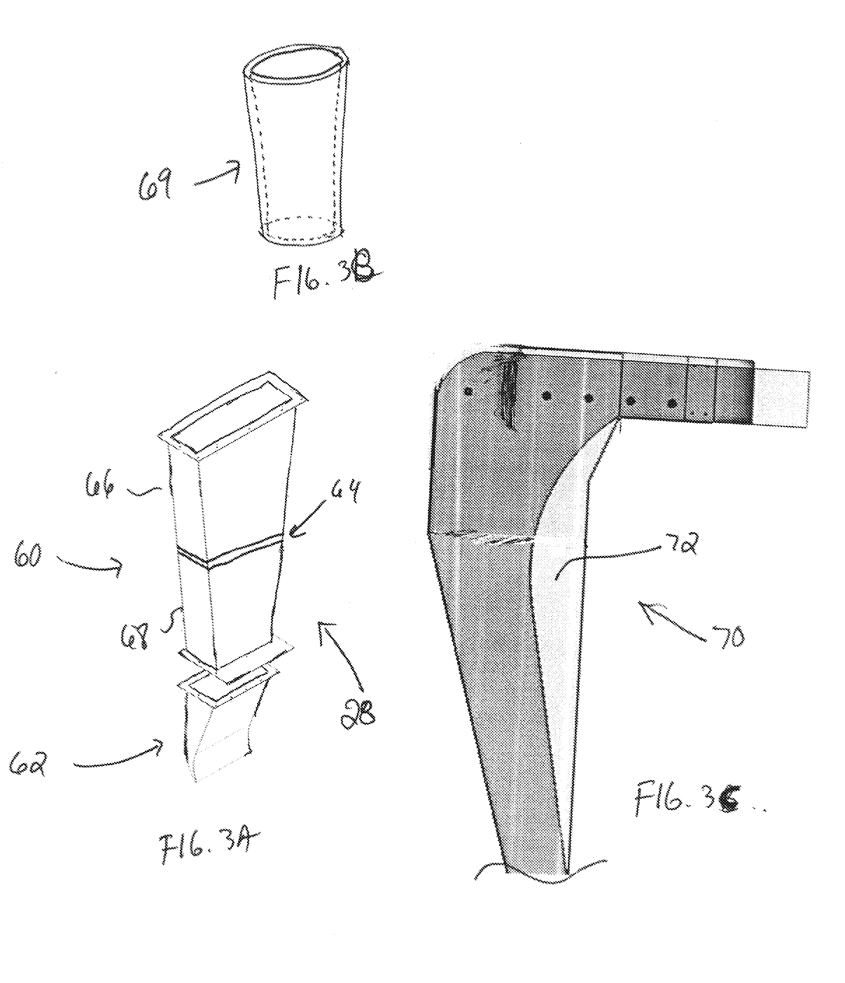

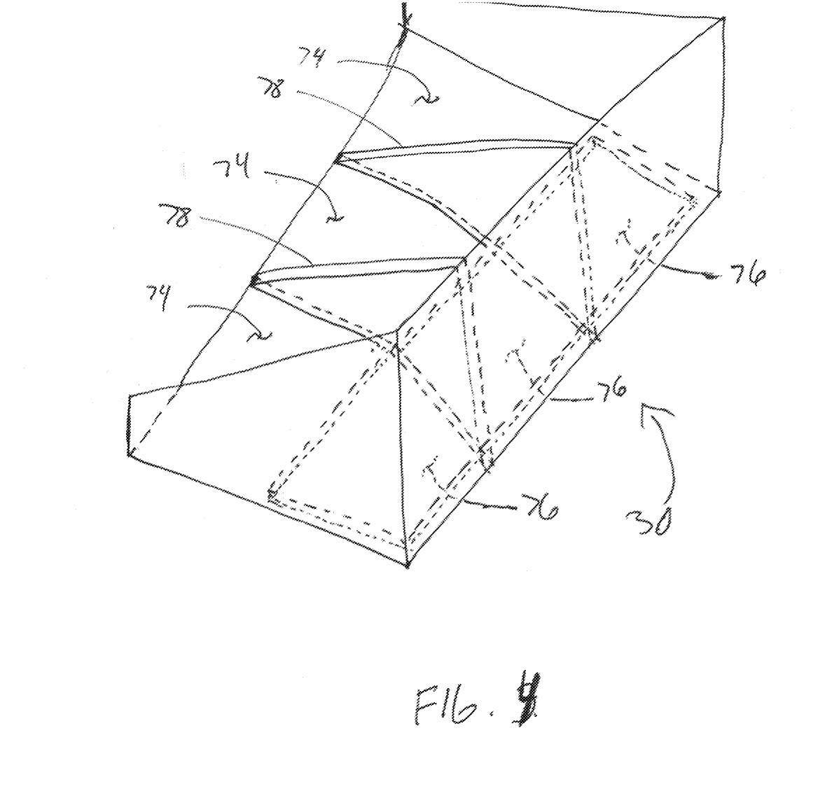

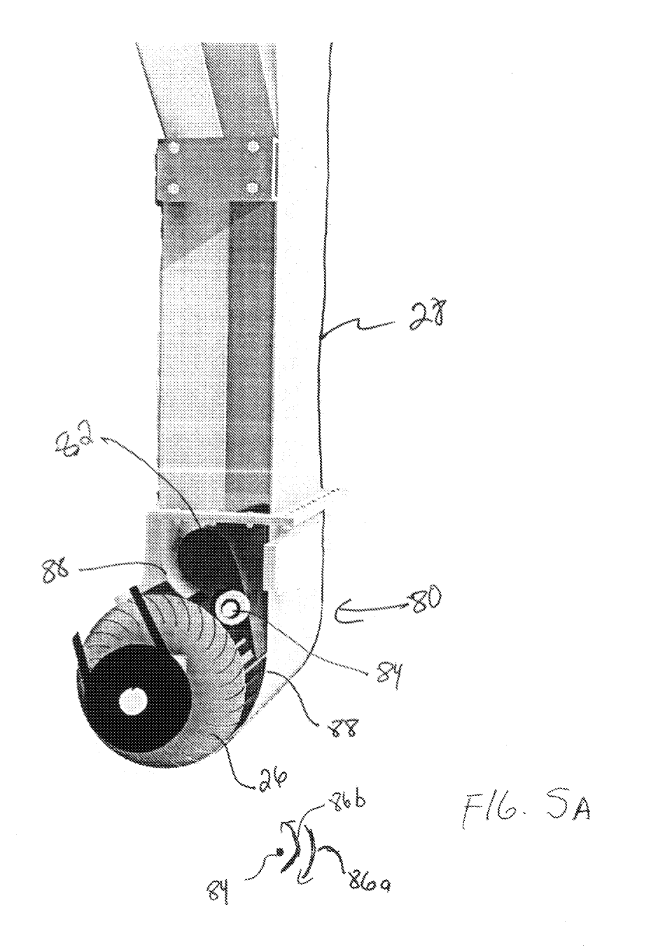

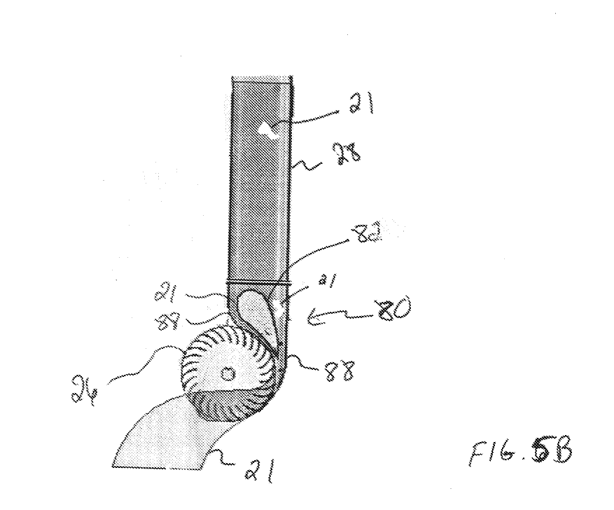

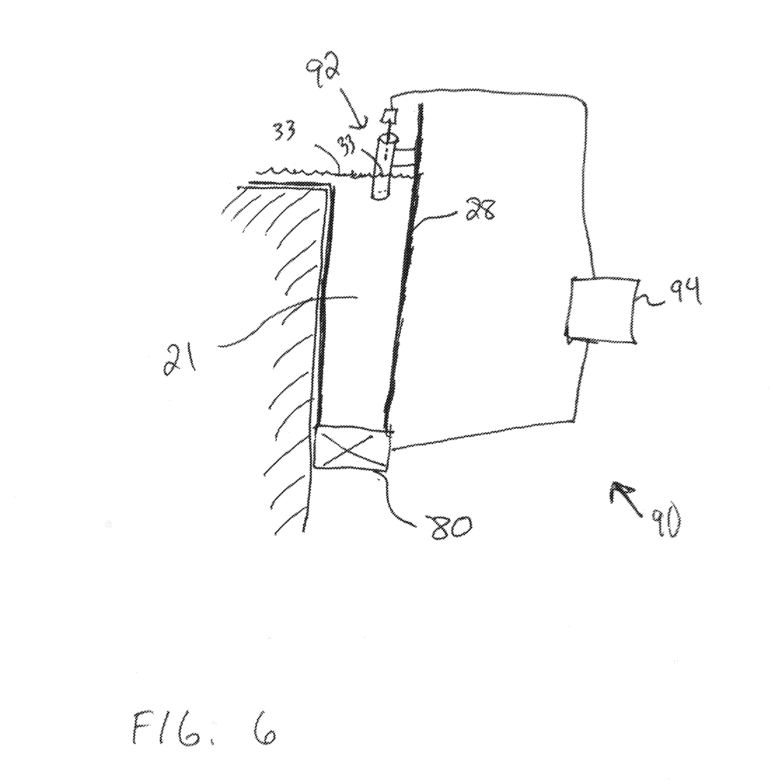

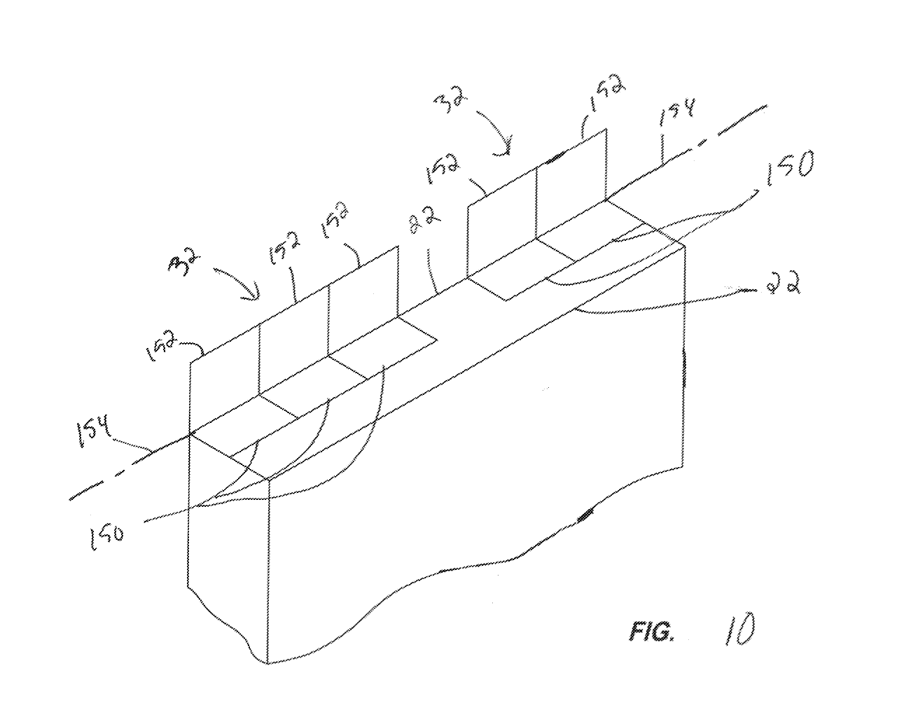

FIG. 1 is a perspective view of a pair of turbine systems 20, each according to an embodiment of the invention. Each system 20 generates electric power from a liquid 21 (here wastewater but can be any liquid) that flows over a ledge 22 and drops into an exit canal 24. The exit canal 24 may then direct the liquid 21 to a stream or river that runs to a lake or other structure that holds the liquid 21, or the exit canal 24 may direct the liquid 21 directly to the ocean. Each turbine system 20 includes an anchor (not shown here but shown and discussed in greater detail in conjunction with FIGS. 2A and 2B) to releasably hold the system 20 to the ledge 22. In addition, each system 20 includes a runner 26 that extracts energy from the liquid 21 flowing through it, a penstock 28 that directs liquid 21 toward the runner 26, and an intake 30 (discussed in greater detail in conjunction with FIG. 4) that directs liquid 21 flowing over the ledge 22 into the penstock 28. The runner 26 (discussed in greater detail in conjunction with FIGS. 7-9B) may be coupled to a generator to generate electric power. The penstock 28 (discussed in greater detail in conjunction with FIGS. 3A-3C) has a length that is adjustable to accommodate changes in the distance between the ledge 22 and the level 29 of the liquid 21 flowing in the exit canal 24. The adjustable length also allows one to modify the head—static pressure—of the liquid 21 flowing through the runner 26, and thus modify the amount of energy in the liquid 21 that the runner 26 can extract. Each turbine system 20 also includes a valve (not shown here but shown and discussed in greater detail in conjunction with FIGS. 5A and 5B) that modifies the flow of the liquid 21 flowing into the runner 26, and a control circuit (also not shown here but shown and discussed in greater detail in conjunction with FIG. 6). The control circuit determines the amount of liquid 21 entering the penstock 28, and, in response to the determined amount, moves the valve to increase or decrease the flow of liquid 21 into the runner 26. Each system 20 also includes a levee 32 (discussed in greater detail in conjunction with FIG. 10) that directs liquid 21 into the intake 30 by preventing liquid 21 from flowing over the ledge 22 between the two intakes 30.

With the anchor, the turbine systems 20 may be quickly and easily mounted to the ledge 22 or any other structure where liquid 21 flows over a drop. Thus, the turbine systems 20 can be quickly and easily moved to one or more different structures, as desired, to extract energy from a flow of liquid 21 wherever a flow drops. With the penstock's adjustable length, the turbine system 20 can be modified as the conditions of the flow change. Thus, the turbine system 20 can be used to extract a substantial amount of energy from a flow of liquid 21 that changes over time and/or that drops a distance that can change over time.

In operation, the level 33 of the liquid 21 held by the wall 34 eventually rises to where it's surface is above the ledge 22. When this occurs, the liquid 21 that is above the ledge 22 and near the intake 30 flows into the intake 30. The intake 30 directs the liquid 21 into the top of the penstock 28. Inside the penstock 28, the liquid drops to the runner 26. The liquid 21 then contacts one or more blades 36 (only two labeled for clarity) as it passes through the runner 26, and then drops into the exit canal 24 to flow toward a stream, river, lake, ocean or some other structure. The contact of the liquid 21 against the one or more blades 36 urges the runner 26 to rotate. The runner 26 is mechanically coupled to an electric generator (not shown for clarity) by a belt 38 such that the rotation of the runner 26 causes the electric generator to rotate a magnet surrounded by conductive wire, and thus generate electricity. The force that the liquid exerts on the one or more blades 36 depends on the head or static pressure of the liquid 21 as it contacts a blade 36. The more head in the liquid 21, the greater the force that the liquid will exert on the blade and thus the more electrical power that can be generated.

FIG. 2A is a partial side view of each of the turbine systems 20 in FIG. 1 showing a side view of an anchor, according to an embodiment of the invention. FIG. 2B is a partial side view of a turbine system showing a side view of another anchor, according to another embodiment of the invention. The anchor may be any desired mechanism that allows one to releasably hold quickly and easily a turbine system in a flow of liquid. For example, as shown in FIG. 2A, the anchor 40 includes a pin 42 that extends into a receptacle 44 to hold the turbine system 20 to the ledge 22. As another example, the anchor 46 shown in FIG. 2B includes a lip 48 that wraps over a corner of the ledge 22 to hold the turbine system 20 to the ledge 22.

Referring to FIG. 2A, in this and other embodiments, the anchor 40 includes a first portion 50 that may be mounted to the intake 30, and a second portion 54 that may be mounted to the ledge 22. The first portion 50 includes the receptacle 44 and may be mounted to the intake 30 using any desired fastening technique that will hold the turbine system 20 to the ledge 22 and in the flow of liquid while the runner 26 rotates and the generator generates power. For example, one or more conventional bolts may fasten the first portion 50 to the intake 30. The second portion 54 includes the pin 42 and may be mounted to the ledge 22 using any desired fastening technique that will hold the turbine system 20 to the ledge 22 and in the flow of liquid while the runner 26 rotates and the generator generates power. For example, one or more conventional anchor bolts for concrete may fasten the second portion 54 to the ledge 22. To releasably hold the turbine system 20 to the ledge 22, one positions the turbine system 20 such that the receptacle 44 is directly above the pin 42, and then drops the turbine system 20 onto the ledge 22 to insert the pin 42 into the receptacle 44. To remove the turbine system 20 from the ledge 22, one simple lifts the turbine system 20 away from the ledge 22.

Referring to FIG. 2B, in this and other embodiments, the anchor 42 includes a body 56 and the lip 48. The body 56 may be mounted to the intake 30 using any desired fastening technique that will hold the turbine system 20 to the ledge 22 and in the flow of liquid while the runner 26 rotates and the generator generates power. For example, one or more conventional bolts may fasten the body 56 to the intake 30. To releasably hold the turbine system 20 to the ledge 22, one positions the turbine system 20 such that the lip 48 extends around a corner of the ledge 22. To remove the turbine system 20 from the ledge 22, one simple lifts the turbine system 20 away from the ledge 22.

FIG. 3A is a perspective view of the penstock 28 included in each of the turbine systems 20 in FIG. 1, according to an embodiment of the invention. FIG. 3B is a perspective view of a penstock, according to another embodiment of the invention. FIG. 3C is a cross-sectional view of a penstock, according to yet another embodiment of the invention. The penstock may be configured as desired to direct liquid from the intake 30 (FIG. 1) and provide the liquid any desired flow characteristics before the liquid contacts the runner 26. For example, the penstock may be configured such that the cross-sectional area oriented perpendicular to the direction of the flow of the liquid changes as the location of the cross-sectional area approaches the runner 26. This may be desirable to increase or decrease the velocity of the flow into the runner 26. In addition the penstock may be configured to minimize pressure loss in the flowing liquid caused by flowing through the intake and the penstock.

Referring to FIG. 3A, in this and other embodiments, the penstock 28 includes an upper body 60 and a lower body 62 that is releasably fastened to the upper body 60 using nuts and bolts (not shown). In this manner, the length of the penstock 28 may be increased, as desired by coupling one or more additional bodies (not shown) between the upper and lower bodies 60 and 62, respectively; or decreased, as desired, by coupling to the lower body 62 an upper body (not shown) having a shorter length than the upper body 60. The length of the penstock 28 may also be adjusted by telescoping the upper body 60 to increase or decrease, as desired, the upper body's length. The telescoping mechanism 64 may be any desired conventional mechanism that allows one to slide the first portion 66 of the upper body 60 relative to the second portion 68 of the upper body to increase or decrease the length of the upper body 60, and hold the position of the first portion 66 relative to the second portion 68 as liquid flows through the penstock 28.

Still referring to FIG. 3A, in this and other embodiments, the penstock 28 includes a cross-sectional area, oriented perpendicular to the direction of the flow through the penstock 28, that is square-shaped and decreases as the cross-sectional area's location along the penstock's length nears the runner 26. The rate at which the cross-sectional area decreases as a function of the area's location relative to the runner 26 may be any desired rate. In the penstock 28, the rate is constant and approximately −0.25 square feet per foot. That is, the cross-sectional area oriented perpendicular to the direction of flow through the penstock 28 decreases by 0.25 square feet relative to the cross-sectional area located 1.0 foot farther from the runner 26, throughout the length of the penstock 28. In other embodiments, the rate may change over the length of the penstock 28. In other embodiments of the penstock, the cross-sectional area may have any desired shape. For example, as shown in FIG. 3B, in this and other embodiments the penstock 69 may have a circular-shaped cross-sectional area.

Referring to FIG. 3C, the penstock 70 may be configured to minimize pressure loss in the flowing liquid caused by flowing through the intake and the penstock. For example, in this and other embodiments, the penstock 70 includes an interior wall 72 having a profile that minimizes abrupt changes in the direction of the liquid's flow, and thus reduces the presence of eddies in the flow through the penstock 70. By reducing the presence of eddies in the flow, one can reduce losses in the flow's static pressure, and thus retain much of the flow's static pressure as the flow enters the runner 26.

FIG. 4 is a perspective view of the intake 30 included in each of the turbine systems 20 in FIG. 1, according to an embodiment of the invention. The intake 30 directs liquid 21 (FIG. 1) into the penstock (FIGS. 1 and 3A-3C) and may be configured as desired to accomplish this. For example, in this and other embodiments, the intake 30 includes a floor 74 to which the anchor 40 and/or 46 (FIGS. 2B and 2C) is mounted to hold the intake 30 to the ledge 22 (FIG. 1). The intake 30 also includes an exit 76 through which the liquid flows to enter the penstock, and a vane 78 (here two) to straighten the flow of liquid passing through the exit 76 and into the penstock. The vanes 78 prevent liquid from flowing across substantially the whole floor 74 and exit 76 in a direction along the long dimension of the floor 74 and exit 76. By doing this the vanes 78 help to prevent liquid flowing into the intake 30 from bunching up over a portion of the exit 76, and thus more evenly distribute the flow of liquid through the exit 76 and into the penstock. This, in turn, helps maximize the amount of liquid 21 flowing through the turbine system 20, and thus the amount of electrical power that the system 20 generates.

FIG. 5A is a cross-sectional view of a portion of each of the turbine systems 20 in FIG. 1 that shows a valve 80 included in each of the turbine systems 20, according to an embodiment of the invention. FIG. 5B is a schematic view of liquid 21 flowing through the valve 80 shown in FIG. 5A, according to an embodiment of the invention.

In this and other embodiments, the valve 80 is located at the bottom of the penstock (FIGS. 1 and 3A-3C) and includes a gate 82 that pivots about the axle 84 in the directions identified by the curved arrows 86a and 86b. As the gate 82 pivots in the direction 86b, the valve 80 doses to reduce the amount of liquid flowing into the runner 26. As the gate 82 pivots in the direction 86a, the valve 80 opens to allow more liquid into the runner 26. A control circuit (discussed in greater detail in conjunction with FIG. 6) controls, as desired, the position of the gate 82 inside the valve 80.

The gate 82 may be configured as desired. For example, in this and other embodiments, the gate 82 is configured to minimize pressure losses in the liquid as the liquid flows past the gate 82 and to also direct the flow of liquid into the runner 26 at an angle that allows the runner 26 to extract much of the flowing liquid's energy. More specifically, the gate 82 has a tear-drop shape that includes a slight curve in the narrow portion of the tear-drop. The shape minimizes the disturbance to the flow of liquid as the liquid flows past the gate 82, and in conjunction with the valve's housing 88 directs most of the flow into the runner at an attack angle that ranges between 5 and 30 degrees relative to a tangent of the runner 26 where the flow contacts the runner 26. The attack angle may be any desired attack angle and is determined by the design of the runner 26 and the runner's blades (discussed in greater detail in conjunction with FIGS. 7-9B). Here the desired attack angle is approximately 16 degrees. Pivoting the gate 82 about an axis through a middle portion of the tear-drop shape, allows the gate 82 to split the flow of liquid in the penstock into two flows that, combined, contact the runner 26 over a substantial portion of its perimeter and at the desired angle of attack.

Other embodiments are possible. For example, the valve 80 may be a conventional ball valve that includes a sphere-shaped gate having a hole through its middle. When the gate is positioned such that the hole is aligned with the direction of the liquid's flow, the valve is fully open. To reduce the flow of liquid through the valve, one rotates the gate inside the valve to position the hole at an angle transverse to the direction of flow.

FIG. 6 is a schematic view a control circuit 90 included in each of the turbine systems 20 in FIG. 1, according to an embodiment of the invention. The control circuit 90 monitors one or more operational parameters of the turbine system 20 and adjusts, as desired, one or more operational variables to obtain a desired performance from the turbine system 20.

For example, in this and other embodiments, the control circuit 90 monitors the amount of liquid flowing into the penstock (FIGS. 1 and 3A-3C), and in response, positions the valve 80 (FIGS. 5A and 5B) to allow substantially the same amount of liquid to flow into the runner 26 (FIG. 1). The control circuit 90 includes a liquid-level sensor 92 that measures the time that it takes for a sound wave to travel from the sensor, bounce off the surface 33 of the liquid 21, and return back to the sensor 92. The control circuit 90 also includes a controller 94 that receives a signal from the sensor that represents the distance that the sound wave travels, compares this signal with the immediately preceding signal, and determines whether or not the liquid level dropped, rose or remained the same. Based on this determination and a desired operational parameter input by a user, the controller 94 then instructs the valve 80 to pivot the gate 82 to increase, decrease or maintain the current flow of liquid into the runner 26. For example, the desired operational parameter input by a user might be to maintain a desired liquid level 33 in the penstock. If the controller 94 determines that the liquid level 33 dropped in the penstock, then the controller 94 instructs the valve 80 to rotate the gate 82 to decrease the flow of liquid 21 into the runner. If the controller 94 determines that the liquid level 33 rose in the penstock, then the controller 94 instructs the valve 80 to rotate the gale 82 to increase the flow of liquid 21 into the runner 26. And if the controller 94 determines that the liquid level 33 remained constant in the penstock, then the controller 94 does not instruct the valve 80 to rotate the gate 82.

In other embodiments, the control circuit 90 may monitor the rotational speed of the runner 26, compare the rotational speed with the optimal speed of the runner 26 that provides the amount of electrical power currently desired, and determine whether or not the runner 26 rotates at the optimal speed. Then, based on this determination, the controller 94 may then instruct the valve 80 to pivot the gate 82 to increase, decrease or maintain the current flow of liquid into the runner 26.

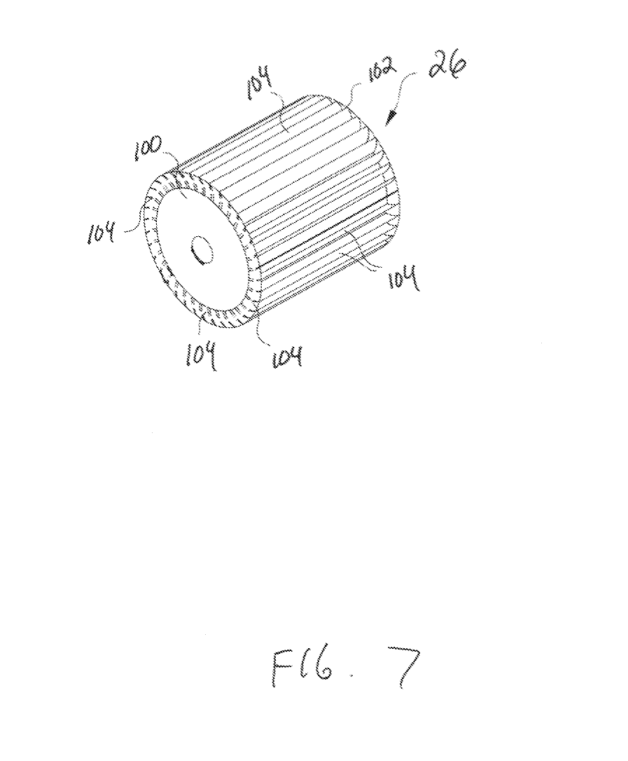

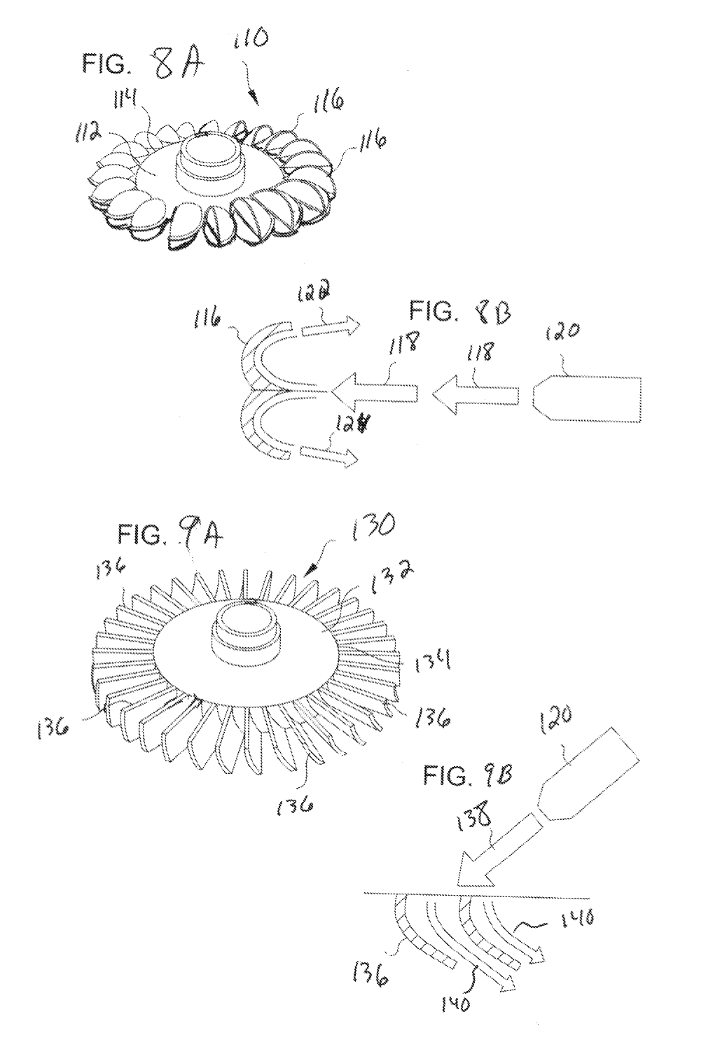

FIG. 7 is a perspective view of a runner included in each of the turbine systems 20 in FIG. 1, according to an embodiment of the invention. FIGS. 8A and 8B are views of a runner, according to another embodiment of the invention. FIGS. 9A and 9B are views of a runner, according to yet another embodiment of the invention. The runner that extracts energy from the liquid 21 (FIG. 1) flowing through it.

Referring to FIG. 7, in this and other embodiments, the runner 26 includes first and second disks 100 and 102 spaced apart from each other, and a plurality of blades 104 extending between the disks 100 and 102 for extracting energy from the liquid flowing into the runner 26. Each blade 104 may be configured an positioned between the disks as desired to allow the runner 26 to extract much of the kinetic energy from the liquid flowing through the valve 80 (FIGS. 5A and 5B) and into the runner 26. For example, in this and other embodiments, each blade 104 has a curved leading edge—the edge of the blade 104 furthest from the center of the disks 100 and 102—that is dull to minimize cleaving the flow of liquid as it contacts the blade 104. By doing this more of the flowing liquids kinetic energy is transferred to the runner 26. Each blade 104 is positioned between the disks 100 and 102 such that the leading edge of the blade 104 forms an angle between 20 and 30 degrees relative to a tangent of the runner 26 at the same location. In addition, each blade is curved such that the blade's trailing edge—the edge of the blade closest to the center of the disks 100 and 102—forms an angle between 80 and 90 degrees relative to a tangent of the runner 26 at the same location.

The runner 26 works well for low to moderate-flow velocities and may be used with an electrical generator having a designed input shaft speed that is slow to moderate.

Referring to FIGS. 8A and 8B, in other embodiments, the turbine system 20 may include a runner 110 that absorbs kinetic energy from the liquid flowing through the penstock and rotates to generate power. The runner 110 includes a disk 112 having a circumference 114, and a plurality of buckets 116 located on the circumference for deflecting the flow of liquid 118.

In operation, the runner 110 uses the force that a flowing liquid 118 imparts on the bucket 116 as the bucket changes the direction of the flow 118 to rotate the runner 110. A nozzle 120 generates the flow 118 having a high flow-velocity and directs the flow 118 toward the runner 110. When the flow 118 strikes a bucket 116, the bucket 116 splits the flow 118 into portions 122 and 124 that are each deflected back toward the nozzle 120. Consequently, each portion 122 and 124 pushes the bucket 116 away from the nozzle 120, causing the disk 112 to rotate.

The runner 110 works well for high-flow velocities, but because the buckets 116 divert the flow 118 back toward the nozzle 120, the flow 118 is also diverted back toward an adjacent bucket 116. Thus, when the runner 110 rotates fast, the flow 118 may impede the runner's rotation. Therefore, the rotational speed of the runner 110 is typically limited, and the disk 112 frequently has a large diameter. Consequently, the runner 110 may be used in large turbine systems 20 and with an electrical generator having a designed input shaft speed that is slow to moderate.

Referring to FIGS. 9A and 6B, in yet another embodiment, the turbine system 20 may include a runner 130 that absorbs kinetic energy from the liquid flowing through the penstock and rotates to generate power. The runner 130 includes a disk 132 having a circumference 134, and a plurality of blades 136 extending radially from the circumference 134 for diverting the flow of liquid 138. The blades 136 typically have a smaller profile and may be located closer to each other around the circumference 134 than the buckets 116 (FIGS. 8A and 8B) around the circumference 114. Thus, the runner 130 may include more blades 136 than the runner 110 (FIG. 8A) includes buckets 116. Consequently, the runner 130 may more efficiently absorb kinetic energy from the flow of liquid 138.

In operation, the runner 130 is similar to the runner 110 except that the nozzle 120 directs the flow of liquid 138 toward the blades 136 at an angle.

The runner 130 also works well for high flow-velocities, but because the blades 136 do not divert the flow of liquid 138 back toward an adjacent blade 136, the diverted flow 140 does not impede the runner's rotation. Thus, the runner 130 may operate at faster rotational speeds than the runner 110, and the disk 132 may have a smaller diameter than the diameter of the disk 112 of the runner 110. Consequently, the runner 130 may be used in small turbine systems and with an electrical generator having a designed input shaft speed that is high.

FIG. 10 is a perspective view of a levee 32 included in the turbine systems 20 in FIG. 1, according to an embodiment of the invention. The levee 32 directs liquid 21 (FIG. 1) into the intake 30 (FIGS. 1 and 4) by preventing liquid 21 from flowing over regions of the ledge 22 where an intake is not located.

The levee 32 may be any desired structure capable of preventing liquid from flowing over a region of the ledge 22. For example, in this and other embodiments, the levee includes a foot 150 that is mounted to the ledge 22 using any desired fastening technique such as anchor bolts as discussed in conjunction with the anchor (FIGS. 2A and 2B) for the turbine system 20. The levee 32 also includes a barrier 152 to prevent liquid from flowing over the region of the ledge that the foot is mounted to. The barrier 152 may be fixed to the foot 150, i.e. does not move relative to the foot 150, or the barrier 152 may he movable relative to the foot 150 to allow one to modify the height of the barrier 152 relative to the ledge 22, and thus allow one to modify the level of the liquid 21 that flows into the intake 30. This may be desirable to allow one to quickly collapse the levee 32 should a sudden or substantial surge in the amount of liquid flowing toward the ledge 22 and intake 30 occur. In such a situation, the whole system may need to simply shed the surge as quickly as possible to avoid damage to the turbine system 20 and/or structure upstream from the system 20. The movement of the barrier 152 relative to the foot 150 may or may not be controlled by the control circuit 90 discussed in conjunction with FIG. 6. In this and other embodiments, the barrier pivots about an axis 154 located where the barrier 152 and foot 150 are joined.

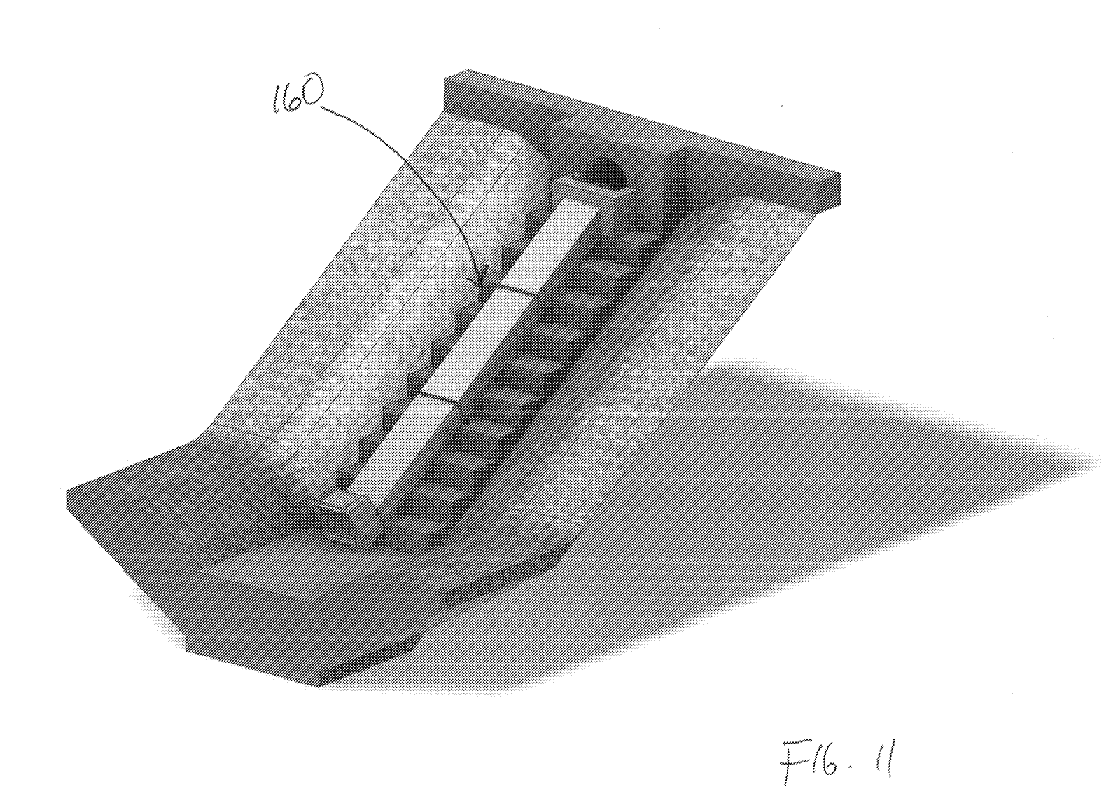

FIG. 11 is schematic view of a turbine system 160, according to an embodiment of the invention. In this and other embodiments, the turbine system 160 is positioned in a flow of liquid that cascades down an incline that is less than 90°. Such inclines often form a spillway for a dam because water vertically falling over a ledge tends to cause substantial corrosion where it lands, which could adversely affect the dam's structure

The preceding discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. A turbine system operable to generate power from a flow of liquid, the system comprising:
a runner operable to receive a flow of liquid and rotate to generate power;
a penstock operable to direct a flow of liquid toward the runner, the penstock having an adjustable length;
an intake operable to direct a flow of liquid into the penstock;
a valve operable to modify the flow of liquid before the runner receives the flow;
a control circuit operable to determine an amount of liquid entering the penstock and, in response to the determined amount, move the valve to increase or decrease the flow of liquid toward the runner;
an anchor operable to releasably hold the turbine system in a flow of liquid.

2. The turbine system of claim 1 wherein the runner includes a Banki runner.

3. The turbine system of claim 1 wherein the penstock has a cross-sectional area that changes as a function of the cross-sectional area's location along the penstock's length.

4. The turbine system of claim 1 wherein the penstock has a cross-sectional area that decreases as the cross-sectional area's location along the penstock's length nears the runner.

5. The turbine system of claim 1 wherein the penstock is configured to reduce the loss of pressure in the liquid as the liquid flows through the intake and the penstock to the runner.

6. The turbine system of claim 1 wherein the intake includes a vane to straighten the flow of liquid entering the penstock.

7. The turbine system of claim 1 wherein the valve is configured to direct the flow of liquid toward the runner.

8. The turbine system of claim 1 wherein the control circuit determines the fluid level in the penstock and monitors the level over time.

9. The turbine system of claim 1 wherein the control circuit includes an ultrasound sensor that directs a sound wave toward the flow of liquid in the penstock and senses the return of the wave after it bounces off of the flow of liquid.

10. The turbine system of claim 1 wherein the control circuit includes a processor that monitors the level of the liquid flowing in the penstock and, in response to a change in the level directs the valve to move to increase or decrease the flow of liquid toward the runner.

11. The turbine system of claim 1 wherein the anchor releasable fastens the intake to a wall of a channel.

12. The turbine system of claim 1 further comprising a levee operable to direct flowing liquid into the intake.

13. The turbine system of claim 12 wherein the levee is adjustable to modify the amount of flowing liquid that bypasses the intake.

14. A power generation system comprising:
a plurality of turbine systems, each turbine system including:
a runner operable to receive a flow of liquid and rotate to generate power;
a penstock operable to direct a flow of liquid toward the runner, the penstock having an adjustable length;
an intake operable to direct a flow of liquid into the penstock;
a valve operable to modify the flow of liquid before the runner receives the flow;
a control circuit operable to determine an amount of liquid entering the penstock and, in response to the determined amount, move the valve to increase or decrease the flow of liquid toward the runner;
an anchor operable to releasably hold the turbine system in a flow of liquid.

15. A method for generating power; the method comprising:
releasably anchoring a turbine system in a flow of liquid;
directing, with an intake of the turbine system, a flow of liquid into a penstock of the turbine system;
directing, with the penstock, the flow of liquid from the intake toward a runner of the turbine system;
rotating the runner with the flow of liquid, to generate power;
monitoring the flow of liquid through the penstock;
moving a valve of the turbine system to increase or decrease the flow of liquid through the penstock in response to the monitored flow.

16. The method of claim 15 wherein monitoring the flow of liquid through the penstock includes monitoring the level of the liquid in the penstock.

17. The method of claim 16 wherein monitoring the level of the liquid in the penstock includes directing a sound wave toward the flow of liquid and sensing the return of the wave after it bounces off the flow.

18. The method of claim 15 wherein directing a flow of liquid with the intake includes straightening the flow with a vane.

19. The method of claim 15 further comprising directing, with a levee, the flow of liquid into the intake.
